(19) United States
(12) Patent Application Publication
(10) Pub. No.: US 2010/0174859 A1
(43) Pub. Date: Jul. 8, 2010

(54) HIGH CAPACITY CONTENT ADDRESSABLE MEMORY

(75) Inventors: JOSE C. PRINCIPE, Gainesville, FL (US); Erion Hasanbelliu, Gainesville, FL (US); Weifeng Liu, Seattle, WA (US)

Correspondence Address: FLEIT GIBBONS GUTMAN BONGINI & BIANCO P.L., ONE BOCA COMMERCE CENTER, 551 NORTHWEST 77TH STREET, SUITE 111, BOCA RATON, FL, 33487, US

(73) Assignee: University of Florida Research Foundation, Inc., Gainesville, FL (US)

(21) Appl. No.: 12/683,223

(22) Filed: Jan. 6, 2010

Related U.S. Application Data
(60) Provisional application No. 61/142,989, filed on Jan. 7, 2009.

(51) Int. Cl. G06F 12/00

(52) U.S. Cl. 711/108; 711/202

(57) ABSTRACT

A set of data is stored in an input space of a kernel content addressable memory. The input space comprising the set of data is transformed into a feature space of higher dimension. The set of data is a set of transformed data within the feature space. An inner product is calculated between the set of transformed data in the feature space using a kernel function.

### CROSS-REFERENCE TO RELATED APPLICATIONS

This application is based upon and claims priority from prior Provisional Patent Application No. 61/142,989, filed on Jan. 7, 2009 the entire disclosure of which is herein incorporated by reference.

### STATEMENT REGARDING FEDERALLY SPONSORED RESEARCH

This invention was made with Government support under Contract No.: NSF (ECS-0601271) and ONR (N00014-07-1-0698). The Government has certain rights in this invention.

### FIELD OF THE INVENTION

The present invention generally relates to the field of content addressable memories, and more particularly relates to kernel based content addressable memories.

### BACKGROUND OF THE INVENTION

Content addressable memories (“CAM”) are one of the few technologies that provide the capability to store and retrieve information based on content. Even more useful is their ability to recall data from noisy or incomplete inputs. However, the input data dimensionality limits the amount of data that CAMs can store and successfully retrieve.

### SUMMARY OF THE INVENTION

In one embodiment, a method for storing and retrieving data in a content addressable form compatible with content addressable memory is disclosed. The method comprises receiving a set of data in an input space. Next the input space comprising the set of data is transformed into a feature space of higher dimension, wherein the set of data is a set of transformed data within the feature space. The transformed data is stored in a content addressable form. To retrieve the transformed data in the content addressable form, a calculation of inner products between the set of transformed data in the feature space using a kernel function is made.

In another embodiment, an information processing system for storing and retrieving data in a content addressable form which is compatible with content addressable memory is disclosed. The information processing system comprises a processor and a kernel content addressable memory communicatively coupled to the processor. A set of data to be stored in an input space of the kernel content addressable memory is received. Next, the input space comprising the set of data is transformed into a feature space of higher dimension, wherein the set of data is a set of transformed data within the feature space. The transformed data is stored; in a content addressable form. To retrieve the transformed data, in the content addressable form, a calculation of an inner product between the set of transformed data in the feature space using a kernel function is made.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention, in which:

FIG. 1 is a block diagram illustrating one environment applicable to kernel-based content addressable memories according to one embodiment of the present invention;

FIG. 2 is a graph illustrating CAM results for both number of pairs and number of characters associated correctly starting from the simple case of presenting only one pair to the association matrix to the more difficult case of having a full load according to one embodiment of the present invention;

FIG. 3 is a graph illustrating the results of both CAM with error correction and the kernel based CAM systems on one noisy bit according to one embodiment of the present invention;

FIG. 4 is a graph illustrating the results of both CAM with error correction and the kernel based CAM systems on three noisy bits according to one embodiment of the present invention;

FIG. 5 is a graph illustrating the results of both CAM with error correction and the kernel based CAM systems on five noisy bits according to one embodiment of the present invention;

FIG. 6 is a graph illustrating the results of Kernel CAM compared to CAM with error correction according to one embodiment of the present invention;

FIG. 7 is a graph illustrating the performance results of both online and offline learning according to one embodiment of the present invention; and

FIG. 8 is a graph illustrating performance results on various kernel sizes according to one embodiment of the present invention.

FIG. 9 is a flow chart of the method for storing data in a content addressable memory.

### DETAILED DESCRIPTION

As required, detailed embodiments of the present invention are disclosed herein; however, it is to be understood that the disclosed embodiments are merely examples of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure and function. Further, the terms and phrases used herein are not intended to be limiting; but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The terms program, software application, and other similar terms as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

Operating Environment

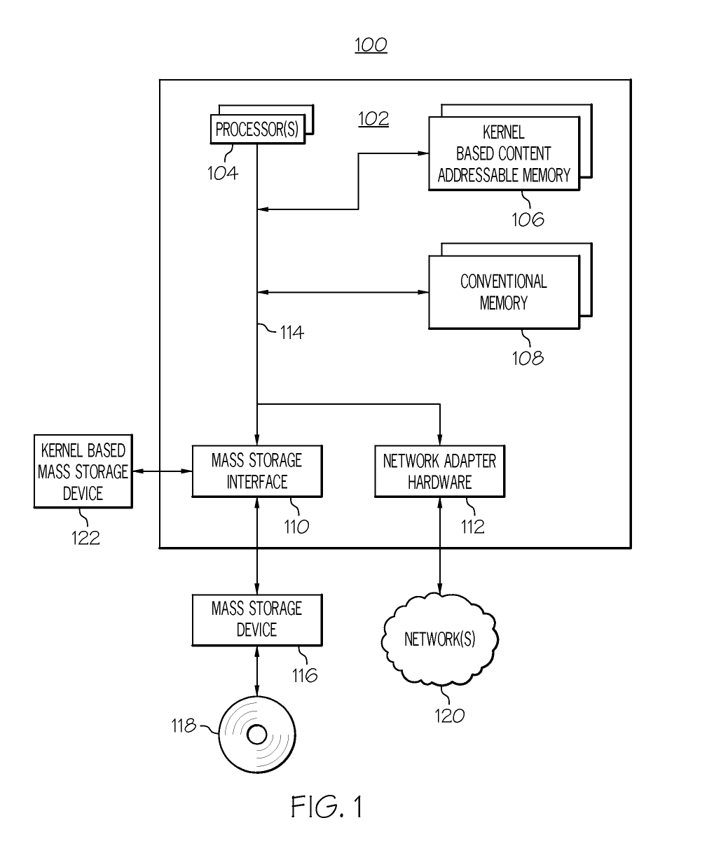

According to one embodiment of the present invention, as shown in FIG. 1, an information processing system 100 is shown comprising one or more kernel based CAMs. It should be noted that FIG. 1 only shows one environment in which a kernel based CAM is applicable. The various embodiments of the present invention are not limited to a single information processing or an information processing system in general. For example, kernel based CAMs can be utilized within a wide variety of electronic devices such as memory storage internal or external to computers, or other information processing systems, routers, computer networking devices, cache controllers, neural networks and data compression and encryption hardware.

In particular, FIG. 1 is a block diagram illustrating a detailed view an information processing system 100 according to one embodiment of the present invention. The information processing system is based upon a suitably configured processing system adapted to implement one or more embodiments of the present invention. Any suitably configured processing system is similarly able to be used as the information processing system 100 by embodiments of the present invention such as a personal computer, workstation, or the like.

The information processing system 100 includes a computer 102. The computer 102 has a one or more processors 104 that are connected to one or more kernel based CAMS 106 and one or more other memories 108 such as Random Access Memory, cache memory, flash memory, or the like. The kernel based CAM 106 is discussed in greater detail below. The one or more processors 102 are also coupled to a mass storage interface 110 and network adapter hardware 112. A system bus 114 interconnects these system components. The mass storage interface 110 is used to connect mass storage devices, such as data storage device 116, to the information processing system 100. Effectively the kernel based CAM 106 can also reside in the Kernel based mass storage device 122 as well. One specific type of data storage device is an optical drive such as a CD/DVD drive, which may be used to store data to and read data from a computer readable medium or storage product such as (but not limited to) a CD/DVD 118.

In one embodiment, the information processing system 100 utilizes conventional virtual addressing mechanisms to allow programs to behave as if they have access to a large, single storage entity, referred to herein as a computer system memory, instead of access to multiple, smaller storage entities such as the kernel based CAM(s) 106, other memories 108, and data storage device 116. Note that the term “computer system memory” is used herein to generically refer to the entire virtual memory of the information processing system 100.

Although only one CPU 104 is illustrated for computer 102, computer systems with multiple CPUs can be used equally effectively. Embodiments of the present invention further incorporate interfaces that each includes separate, fully programmed microprocessors that are used to off-load processing from the CPU 104. An operating system (not shown) included in the main memory is a suitable multitasking operating system such as the Linux, UNIX, Windows XP, and Windows Server 2003 operating system. Embodiments of the present invention are able to use any other suitable operating system. Some embodiments of the present invention utilize architectures, such as an object oriented framework mechanism, that allows instructions of the components of operating system (not shown) to be executed on any processor located within the information processing system 102. The network adapter hardware 112 is used to provide an interface to a network 120. Embodiments of the present invention are able to be adapted to work with any data communications connections including present day analog and/or digital techniques or via a future networking mechanism.

Overview Of Content Addressable Memories

Human Memory is believed to be associative, where events are linked to one another in such a way that the occurrence of an event, i.e., a stimulus, triggers the emergence of another event, i.e., a response. This association is strengthened through time by the constant trigger of the response via the stimulus event; a learning process that is known as Hebb's rule (See D. O. Hebb, The organization of behavior, New York: Wiley, 1949, which is hereby incorporated by reference in its entirety). There are two main types of associative memory: auto-associative memory where a stored pattern which most closely resembles the stimulus pattern is retrieved and hetero-associative memory where the retrieved pattern is the response of a stored stimulus that closely matches the input pattern. A well known type of auto-associative memory is the Hopfield model (See J. J. Hopfield, “Neural networks and physical systems with emergent collective computational abilities,” in Proceedings of the National Academy of Sciences, vol. 79, 1982, pp. 2554-2558, which is hereby incorporated by reference in its entirety), which is an unsupervised recurrent neural network. The Hopfield network computes its output recursively in time until it reaches a stable (attractor) point which is one of the stored patterns. Feedforward Auto or Hetero-associative memories, on the other hand, are simpler and the output pattern is computed immediately from the stimulus pattern and the association matrix (memory) (See J. A. Anderson, An Introduction to Neural Networks. The MIT Press, 1995, ch. 7, which is hereby incorporated by reference in its entirety).

A CAM can be thought as a linear network being trained with input output patterns very similarly to regression. In order to avoid cross-talk amongst the stored patterns, the stored patterns must be orthogonal. Since a N dimensional vector space has only N orthogonal directions, it is only possible to store without crosstalk N memories with N components. This becomes the most fundamental limitation of CAMs.

CAMs utilize Hebb's learning rule to associate a certain input state vector x with an output state vector d. The connections between the input and output patterns are stored in a matrix W, which is computed using the outer product rule W=d·x^{T}. The system is considered to have learned the association when whenever an input vector x is presented, the corresponding output vector d is retrieved. The output state vector is retrieved by multiplying the connection matrix with the input vector as follows:

$${d}_{r} = W \cdot {x}_{r} = {\sum }_{ i = 1}^{N} {d}_{i} \cdot {x}_{i}^{T} \cdot {x}_{r} = {\sum }_{i = 1}^{N} {d}_{i} \cdot 〈 {x}_{i} , {x}_{r} 〉 \qquad ( EQ . 1 )$$

The hetero-associative memory works well when the input vectors are orthogonal. For example, assume the input vectors {x} are normalized and orthogonal, then for every pair of associations xᵢ→dᵢ there is an associative matrix Wᵢ=dᵢ·xᵢ^{T} , where X^{T} is the transpose of input vectors x. The overall matrix W is then the sum of all these individual matrices

$$W = {\sum }_{i} {W}_{i} .$$

If dⱼ associated with xⱼ is to be retrieved, the following computation can be performed:

$$\begin{matrix}W \cdot {x}_{j} = {\sum }_{i} {W}_{i} \cdot {x}_{j} \\ = {\sum }_{i \neq j} {W}_{i} \cdot {x}_{j} + {W}_{j} \cdot {x}_{j} \\ = {\sum }_{i \neq j} {d}_{i} \cdot \underbrace{{x}_{i}^{T} \cdot {x}_{j}}_{= 0} + {d}_{j} \cdot \underbrace{{x}_{j}^{T} \cdot {x}_{j}}_{= 1} = {d}_{j}\end{matrix}$$

Thus, the system reconstructs the output pattern perfectly as long as the stored pairs are orthogonal. However, in general, the input vectors are not orthogonal, and as a result, there is potential for interference between the different association pairs. Another obvious limitation of associative memory is its limited capacity. The number of pairs that can be successfully stored in the connection matrix is dependent on the dimensionality of the state vectors; e.g., if the data dimensionality is N, there can only be stored N orthogonal vector pairs without interference. This number decreases when the orthogonality rule is not followed.

The crosstalk among the pairs can be reduced by incorporating an error correction mechanism into the formula (See F. M. Ham, I. Kostanic, Principles of Neurocomputing for Science & Engineering. McGraw-Hill, 2001, which is hereby incorporated by reference in its entirety). In associative memories, whenever a new input-output pair needs to be stored in the connection matrix, the outer product of the input and output vectors is added to the existing matrix,

Wₖ=Wₖ₋₁+dₖ·xₖ^{T}, (EQ. 2)

where W₀=0. The error correction method follows the steepest descent approach and includes learning from the error between the desired vector and the output of the association matrix, e=dₖ−W·xₖ, using the least mean square algorithm as shown in the following formula:

W(t+1)=W(t)+μ·[dₖ−W(t)·xₖ]·xₖ^{T}, (EQ. 3)

where W(0)32 0. This is a combination of both Hebbian and anti-Hebbian rules. The anti-Hebbian term decorrelates the input and the system output, thus reducing the crosstalk and consequently improving the performance of the associative memory.

However, in order for the association matrix using error correction to reconstruct all the previous outputs correctly, it needs to be retrained whenever a new input-output pair is introduced. Equation (3) needs to be repeated for all the associations in no particular order and this process needs to be repeated till the error e is below a tolerance level. Due to this process, the error correction can be applied only to an offline system, which adds another restriction to CAM.

Kernel Based Content Addressable Memories

The following is a more detailed discussion on the kernel based CAM 106, which increases the amount of information that can be stored by implementing CAMs in a reproducing kernel Hilbert space where the input dimension is practically infinite, effectively eliminating the input dimension limitation of convention CAMS. Kernel methods implement a data transformation from the input space into a feature space of usually much higher dimension (See B. Scholkopf, “Statistical learning and kernel methods,” 2000, which is hereby incorporated by reference in its entirety). The inner product between the transformed data in the feature space is calculated using the kernel function as follows: let Φ(•) represent the mapping from the input space X into the feature Hilbert space F, Φ:X→F, then the kernel function is K(xᵢ,xⱼ)= [symbol] Φ(xᵢ),Φ(xⱼ) [symbol] . One embodiment of the present invention uses the kernel property/relation where the kernel function computes the inner product by implicitly mapping the data into the feature space, thus allowing us to obtain nonlinear transformation in terms of inner products without knowing the exact mapping Φ(•). Note that the kernel function, in one embodiment, satisfies Mercer's conditions (See V. Vapnik, The nature of statistical learning theory, Springer, New York, 1995, which is hereby incorporated by reference in its entirety).

This feature space is also a reproducing kernel Hilbert space as the span of the functions {K(•,x):x∈X} defines a unique functional Hilbert space (See N. Aronszajn, “Theory reproducing kernels,” in Transactions of the American Society, vol. 68, 1950, pp. 337-404, which is hereby incorporated by reference in its entirety), where a nonlinear mapping from the input space into an RKHS can be defined as Φ(x)=K (•,x) such that

[symbol]

Φ(xᵢ),Φ(xⱼ) [symbol] = [symbol] K(•,xᵢ), K(•,xⱼ) [symbol] =K(xᵢ,xⱼ) (EQ. 4)

In one embodiment, the Gaussian kernel is selected as the kernel function for the kernel based CAM 106:

$$K ( {x}_{i} , {x}_{j} ) = exp ( \frac{- {‖ {x}_{i} - {x}_{j} ‖}^{2}}{2 {σ}^{2}} ) \qquad ( EQ . 5 )$$

because the Gaussian kernel produces in principle an infinitely dimensional space (practically defined by the number of examples utilized). Due to this infinite dimensional mapping, the number of orthogonal patterns becomes infinite and it lifts the most severe limitation of CAMs in the input space. This allows the kernel based CAM 106 to overcome both the limited capacity and the crosstalk problems since transforming the data into feature space increases the data dimensionality and the probability that the input vectors are orthogonal. To retrieve the desired pattern from its corresponding input vector in the RKHS, the following is computed:

$${d}_{r} = {\sum }_{i = 1}^{N} {d}_{i} \cdot {Φ}^{T} ( {x}_{i} ) \cdot Φ ( {x}_{r} ) = {\sum }_{i = 1}^{N} {d}_{i} \cdot K 〈 {x}_{i} , {x}_{r} 〉 \qquad ( EQ . 6 )$$

where the retrieved output is the sum of all the stored output patterns weighed on the closeness of the current stimulus to the stored input patterns. The transformation of the input patterns into RKHS can be thought of as transforming the data from the input space into a feature space. The transformation is simply extraction of features from the stimulus thus providing the system with richer information to strengthen the input/output pattern connection. It is important to note that other functions are within the true scope and spirit of the present invention in addition to a Gaussian kernel function as long as the kernel function is any positive definite function of two arguments.

The Φ(•) transformation is unknown, which requires that the actual input-output pairs be stored. During the retrieval procedure the kernel function between the stimulus and all stored inputs is computed to decide which output vector dᵢ is the desired response. Since all the association pairs need to be stored, this method may require more storage space than the CAM, but it outperforms the accuracy of the CAM. For example, assume that M vector pairs need to be stored where the vector dimension is N for both the input and output. In the case of content addressable memory, the connection matrix is N×N and thus memory required is N² regardless of the number of pairs. With a kernel based CAM, there are M 2×N pairs that need to be stored and thus memory required is 2MN. Consequently, more storage space is needed whenever

$$M > \frac{N}{2} .$$

In the following discussion, various embodiments for reducing the number of pairs stored are illustrated along with experimental results.

Two methods on (1) generalization—ability to perform well on noisy data, (2) limited memory space, and (3) online learning. To perform these tests two applications were used: (1) a vector association problem, and (2) the handwritten digit recognition problem. The vector association problem is a simple application of associating vectors of characters where each character is encoded using 5 bits was utilized. A pair of two character strings and their corresponding bit vectors are shown below to illustrate the encoding of the association on the connection matrix.

$$vb a 7$$

$$01101 \; 01000 10000 \; 00111$$

This application is simple, but helps illustrate the shortcomings of conventional CAMs. The handwritten digit recognition problem uses the NIST database. In this problem, the system needs to associate a set of figures representing different handwritten digits with their corresponding digits.

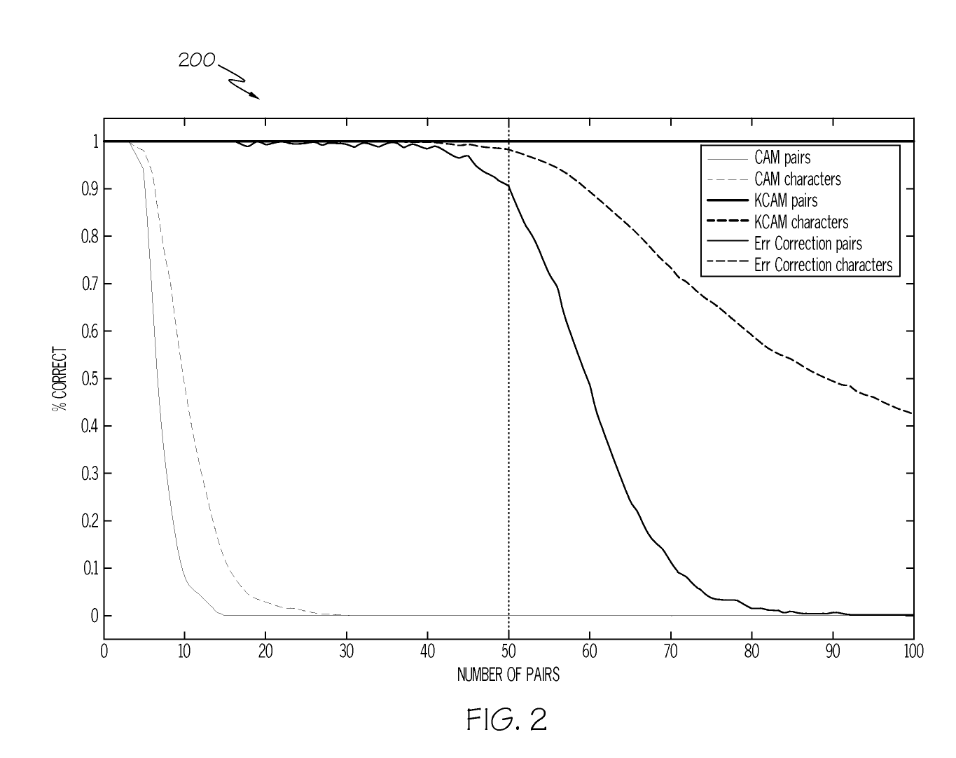

The first experiment tests each method to measure their performance on a range of pairs available. This experiment is useful to show the saturation of the association matrix in the CAM case. The association pairs are composed of 10 characters for both the input and output vectors resulting in an association matrix of size 50×50. This means that at most 50 pairs of 10 character strings can be stored without any interference. FIG. 2 shows a graph illustrating the CAM results for both number of pairs and number of characters associated correctly starting from the simple case of presenting only one pair to the association matrix to the more difficult case of having a full load. The CAM system performs well up to four pairs (8% load) and then it starts degrading. This is due to the input pairs not being orthogonal and starting to interfere with one another. After 25 pairs there is no correct identification at all due to the large crosstalk between the pairs at this point.

The number of characters misinterpreted degrades at a lesser rate as the association matrix saturates meaning that part of the vector is still associated correctly. The CAM with error correction performs much better. By removing the crosstalk, it is able to correctly associate pairs beyond the limitations of CAM. However, as the number of association pairs increases this method becomes prone to misidentifications as well. When the number of pairs reaches the full load, 50, the system's performance degrades drastically as the full memory capacity is reached. The kernel based CAM 106, on the other hand, performs well regardless of the number of pairs presented.

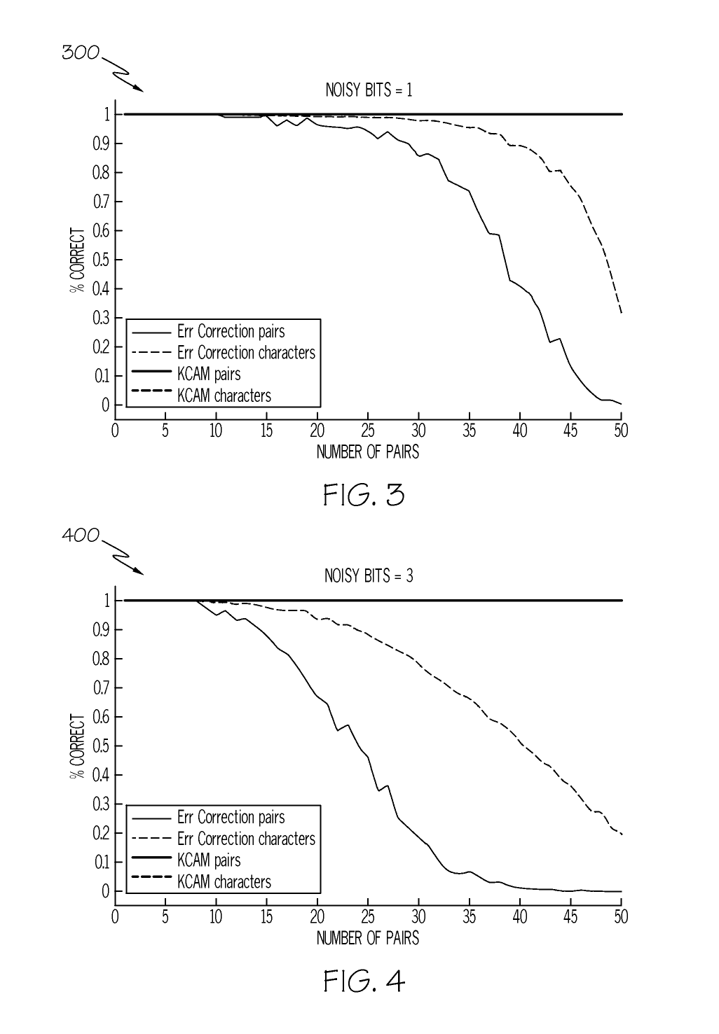

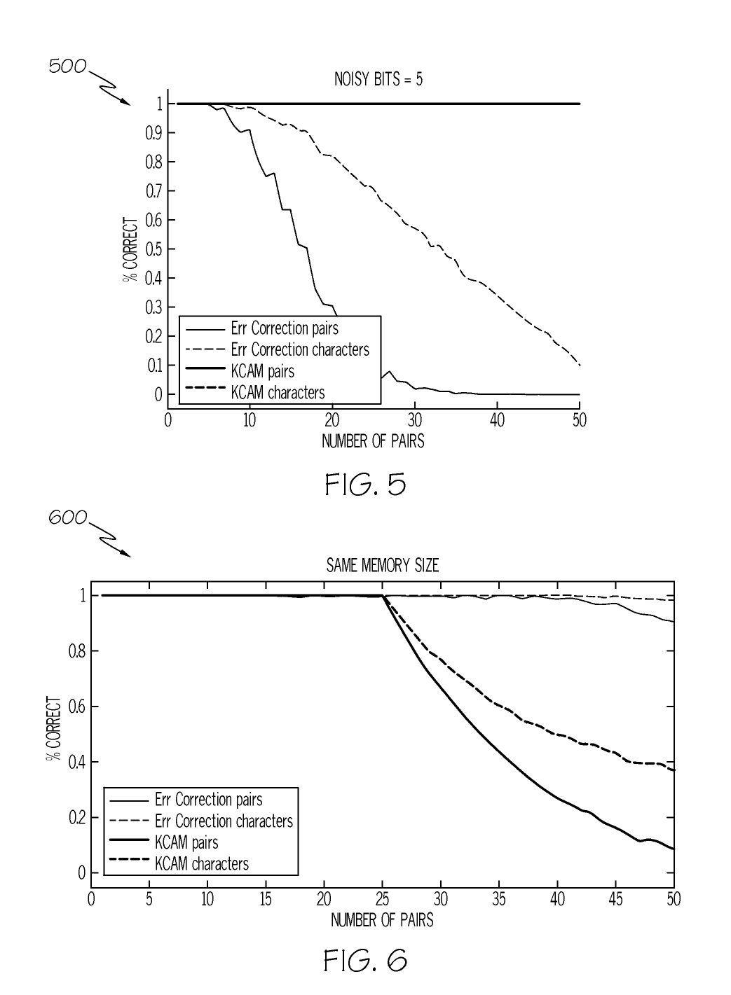

With respect to the generalization category, each system was tested on its ability to retrieve the original vectors and to what degree when noise is present. At first, only one bit is changed. FIG. 3 shows a graph illustrating the results of both CAM with error correction and the kernel based CAM 106 systems on one noisy bit. As the number of pairs reaches the limit, the performance of CAM deteriorates faster. The performance of kernel based CAM 106, on the other hand, is invariant to this amount of noise. This point is further brought out by showing the performance on three and five noisy bits as shown by the graph in FIG. 4 and the graph in FIG. 5, respectively. The CAM system's performance degrades faster, while kernel based CAM 106 continues to have a perfect association.

These results are explained by observing the performance of CAM system when few pairs are available, say five, and when the system is almost full, say forty five. When there are only few pairs present in the system, there is sparse information stored, and regardless of noise the system can still perform well. However, when the system is close to its capacity, even with the error correction mechanism, the system is still sensitive to noise. This explanation is also applied to kernel based CAM where the input vectors are transformed into a higher dimension space and thus are sparser than in the original space and as a result are robust to this amount of noise.

Kernel CAM occupies more memory than CAM whenever number of pairs, M, is greater than half the input dimension, N. Since memory space may become an issue when M>>N, a test Kernel CAM's performance is performed by restricting it to use the same space allocated for CAM, e.g. N2. A form of redistribution using the k-means neighborhood algorithm is applied. Since it is heteroassociative memory, the redistribution is considered in the joint space of the input and output vectors. FIG. 6 us a graph showing the results of Kernel based CAM 106 compared to CAM with error correction. As discovered, up to half the number of samples the Kernel CAM performs without any errors as it stores all the association pairs. The performance starts to deteriorate as we redistribute the available input-output vector pairs to represent all the pairs. There are two reasons for this drop in performance. First, there are very few vectors in a high dimension space. The data is very sparse which makes it difficult to cluster the pairs and have good representation vectors. Second, on this problem, there is no structure between the input/output vectors. This makes it even more difficult to cluster similar input vectors together.

In order to test the capability of kernel based CAM 106 to correctly associate patterns on a limited storage, the kernel based CAM 106 was applied to the handwritten digit recognition problem. The system is tested on 1 to 100 samples from each digit storing only 20 samples per digit. To select the samples that will be stored the following cost function was used:

$${max}_{S} {J}_{S} = {\sum }_{{x}_{i} ∈ X} {K}_{Si}^{T} {K}_{SS}^{- 1} {K}_{Si} , \qquad ( EQ . 7 )$$

where K_{SS} is a square matrix of dot products of the selected samples, and K_{Si} is a vector of dot product between xᵢ and the selected sample set S (See G. Baudat, F. Anouar, “Kernel-based methods and function approximation,” in International Joint Conference on Neural Networks, vol. 2, 2001, pp. 1244-1249, which is hereby incorporated by reference in its entirety).

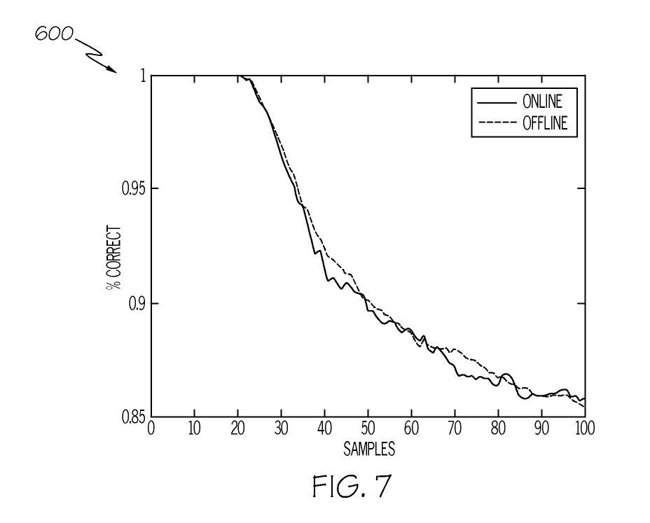

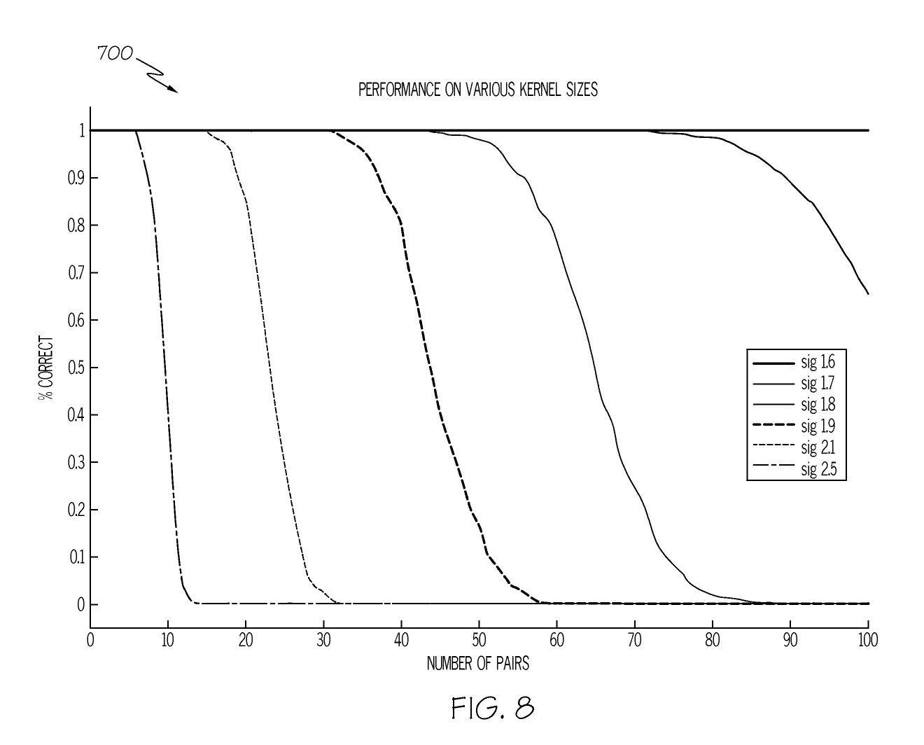

The system is tested online, which is expected in real life problems; and, active learning is used to determine if the system would benefit from the current input, which in that case would replace one of the previously stored samples. FIG. 7 shows a graph illustrating the performance results of both online and offline learning. The system is capable of correctly identifying over 85% of the data with only 20% storage space. In addition, the performance of the online system is comparable to the offline one. The system can actually perform better if it is allowed to continue storing samples until it can fully create a basis for the data in the feature space, that is, until K_{SS} is no longer invertible.

If there is the need to increase memory so that additional pairs can be saved, the CAM is limited to the dimensionality of input vectors. Once the limit of N pairs is reached, even in the ideal case, there will be crosstalk with the introduction of any new pair. This is true even when error correction is applied as was shown in FIG. 2. Another problem that arises from CAM with error correction is that if a new pair is introduced, in order to reduce the association error, all the pairs need to be present. Hence, this method is useful only when all the pairs are available at the beginning, that is, offline learning. Any new pair would require retraining the association matrix and thus additional storage for storing all the previous pairs, which defeats the purpose of the association matrix. In addition, as the number of pairs increases, error correction due to gradient descent learning approach takes longer to train especially when the number of pairs is close to the limit. The kernel based CAM 106, on the other hand, has an incremental memory. All it requires is additional space for the new pair. No additional training is needed since that is part of the retrieval process. Training may be needed on the selection of key vectors when storage space is limited. The kernel based CAM 106 is a suitable method for online training where data are received one sample at a time, which is usually the case.

The kernel size that was used throughout the experiments is 1, although the system performed well on a range of sizes around 1. The selection of kernel size is usually problem specific. Since the kernel size is a compromise between generalization and infinite memory, cross-validation was used on a small dataset to find the correct kernel size based on the level of generalization that was desired.

In addition, it can be proven that as the kernel size increases the performance of the kernel based CAM 106 reduced to the standard CAM. Equation (1) above shows that a desired output vector is retrieved through inner product multiplication between the stimulus and the stored input vectors. It can be shown that the Gaussian kernel function on equation 6, shown above, reduces to an inner product for large kernel sizes. The Taylor series expansion of the Gaussian kernel function is:

$$exp ( \frac{- {‖ {x}_{i} - {x}_{r} ‖}^{2}}{2 {σ}^{2}} ) = 1 - \frac{{‖ {x}_{i} - {x}_{r} ‖}^{2}}{2 {σ}^{2}} + \frac{{‖ {x}_{i} - {x}_{r} ‖}^{4}}{8 {σ}^{4}} - \frac{{‖ {x}_{i} - {x}_{r} ‖}^{6}}{48 {σ}^{6}} + \frac{{‖ {x}_{i} - {x}_{r} ‖}^{8}}{384 {σ}^{8}} - … \qquad ( EQ . 8 )$$

where for large values of sigma the third and later terms will be close to zero, thus negligible. This results in:

$$exp ( \frac{- {‖ {x}_{i} - {x}_{r} ‖}^{2}}{2 {σ}^{2}} ) ≅ 1 - \frac{{‖ {x}_{i} - {x}_{r} ‖}^{2}}{2 {σ}^{2}} = 1 - \frac{{x}_{i}^{2} - 2 {x}_{i} {x}_{r} + {x}_{r}^{2}}{2 {σ}^{2}} . \qquad ( EQ . 9 )$$

The inputs are normalized, as is usually the case in CAM, to receive a correct output value (with no amplitude distortion), thus the xᵢ² and xᵣ² terms are be equal to 1 and be constant during any retrieval. The only term that affects the retrieval is the scaled inner product of the two inputs.

$$exp ( \frac{- {‖ {x}_{i} - {x}_{r} ‖}^{2}}{2 {σ}^{2}} ) ≅ ( 1 - \frac{1}{{σ}^{2}} ) + \frac{1}{{σ}^{2}} 〈 {x}_{i} , {x}_{r} 〉 \qquad ( EQ . 10 )$$

So, for large kernel sizes kernel based CAM 106 is linearly related to CAM. The original desired vector could be retrieved using simple algebra. This is also confirmed by the experimental results shown in FIG. 8. For kernel size of 1.6 and lower the system correctly identifies all the pairs presented. As the kernel size is increased, the performance lowers and approaches the performance of standard CAM.

In general, it is very difficult to store a lot of pairs using associative memory because it is a sparse method. It requires a lot of memory to save little information—similar to our brain. Kernel based CAM is a better generalization method than CAM. In fact, this is the one of the many advantages of kernel based CAM over CAM. Kernel CAMs 106 allow one to cluster noisy patterns based on the kernel size and provide a good association. Kernel based CAM is also more useful because it provides a degree of association; e.g. one can receive percentages as to which desired pattern the resulting output is the closest and also a confidence level based on the value of the function K<•,•>. This is a very useful feature, where it is important for the system to decide that it does not know enough to make a decision rather than to just provide an answer that may be wrong [0026], or provide a level of confidence.

When the memory space allocated is restricted, kernel based CAM's performance deteriorates as it tries to redistribute the stored data to represent the whole dataset. The system may perform better if enough storage is provided for the system to create an actual basis for the dataset in the feature space.

Finally, if the memory of the system needs to be increased so that it can accurately associate more pairs of data as they become available, N→N+1, CAM's performance decreases as the matrix capacity is reached, especially when going beyond this limit. The error correction mechanism cannot be used in this case as it would require all the previous N points to retrain the system, which defeats the purpose of the association memory. Kernel based CAM memory, on the other hand, is increased incrementally. All that is required is: in the case of unlimited storage space, to store the new input-output pair, and in the case of limited storage, to compare the new pattern to the current state of the system and to replace an existing pair if the new pair provides more information.

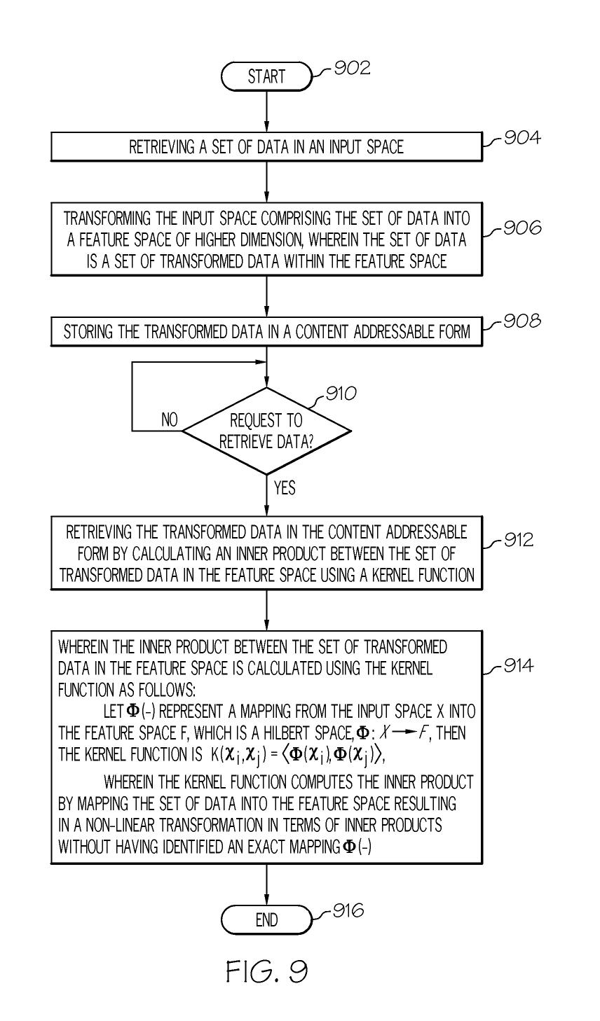

Referring now to FIG. 9, shown is a generalized flow chart of the method for storing and retrieving data in a content addressable memory. The method begins in step 902 and immediate proceeds to step 904 where a set of data in input space is retrieved or collected. Next in step 906, the input data received is transformed into a feature space of higher dimension, wherein the set of data is a set of transformed data within the feature space. The transformed data is stored in a content addressable form in step 908. The complete the storage portion of the flow. Now the flow for retrieving the transformed data is described. Once a request to retrieve is received in step 910, the process continues to step 912 where the transformed data in the content addressable form is retrieved by calculating inner products between the set of transformed data in the feature space using a kernel function to retrieve the association. Optional step 914 details how the retrieving step is carried out using wherein the inner product between the set of transformed data in the feature space is calculated using the kernel function as follows: Φ(•) represent a mapping from the input space x into the feature space f, which is a Hilbert space, Φ:X→F, then the kernel function is K(xᵢ,xⱼ)= [symbol] Φ(xᵢ),Φ(xⱼ) [symbol] , wherein the kernel function computes the inner product by mapping the set of data into the feature space resulting in a non-linear transformation in terms of inner products without having identified an exact mapping Φ(•) and the process ends in step in 916.

### Non-Limiting Examples

The present invention can be realized in hardware, software, or a combination of hardware and software. A system according to one embodiment of the present invention can be realized in a centralized fashion in one computer system or in a distributed fashion where different elements are spread across several interconnected computer systems. Any kind of computer system—or other apparatus adapted for carrying out the methods described herein—is suited. A typical combination of hardware and software could be a general purpose computer system with a computer program that, when being loaded and executed, controls the computer system such that it carries out the methods described herein.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

The kernel associate memory can be used as the underlying hardware and software infrastructure to create content addressable memories where, just like human memory, the number of items stored can grow even when the physical hardware resources remain of the same size.

What is claimed is:

1. A method for storing and retrieving data in a content addressable memory, the method comprising:
receiving a set of data in an input space;
transforming the input space comprising the set of data into a feature space of higher dimension, wherein the set of data is a set of transformed data within the feature space;
storing the transformed data in a content addressable form; and
retrieving the transformed data in the content addressable form by calculating inner products between the set of transformed data in the feature space using a kernel function.

2. The method of claim 1, wherein the inner product between the set of transformed data in the feature space is calculated using the kernel function as follows:
let Φ(•) represent a mapping from the input space X into the feature space F, which is a Hilbert space, Φ:X→F, then the kernel function is K(xᵢ,xⱼ)= [symbol] Φ(xᵢ), Φ(xⱼ) [symbol] .
wherein the kernel function computes the inner product by mapping the set of data into the feature space resulting in a non-linear transformation in terms of inner products without having identified an exact mapping Φ(•).

3. The method of claim 2, wherein the feature space is a reproducing kernel Hilbert space.

4. The method of claim 3, wherein calculating the inner product between the set of transformed data in the feature space using the kernel function, further comprises:
retrieving a desired pattern associated with the set of data from a corresponding input vector in the reproducing kernel Hilbert space by calculating:
$${d}_{r} = {\sum }_{i = 1}^{N} {d}_{i} \cdot {Φ}^{T} ( {x}_{i} ) \cdot Φ ( {x}_{r} ) = {\sum }_{i = 1}^{N} {d}_{i} \cdot K 〈 {x}_{i} , {x}_{r} 〉$$
where d is an output state vector, K is the kernel function, r denotes a retrieved output vector, and i is an index, and
wherein the desired pattern is a sum of all stored output patterns weighed on a closeness of a current stimulus to a set of stored input patterns.

5. The method of claim 1, wherein the kernel function is a Gaussian kernel
$$K ( {x}_{i} , {x}_{j} ) = exp ( \frac{- {‖ {x}_{i} - {x}_{j} ‖}^{2}}{2 {σ}^{2}} ) .$$

6. The method of claim 5, wherein the kernel function is any positive definite function of two arguments.

7. The method of claim 2, wherein the Hilbert space is a function span of {K(•,x): x∈X}.

8. An information processing system for storing and retrieving data in a content addressable memory, the information processing system comprising:
a processor;
a kernel content addressable memory communicatively coupled to the processor, wherein the kernel content addressable memory is adapted to:
receiving a set of data in an input space;
transform the input space comprising the set of data into a feature space of higher dimension, wherein the set of data is a set of transformed data within the feature space;
storing the transformed data in a content addressable form; and
retrieving the transformed data in the content addressable form by calculating an inner product between the set of transformed data in the feature space using a kernel function.

9. The information processing system of claim 8, wherein the inner product between the set of transformed data in the feature space is calculated using the kernel function as follows:
let Φ(•) represent a mapping from the input space X into the feature space F, which is a Hilbert space, Φ:X→F, then the kernel function is K(xᵢ,xⱼ)= [symbol] Φ(xᵢ),Φ(xⱼ) [symbol] ,
wherein the kernel function computes the inner product by mapping the set of data into the feature space resulting in a non-linear transformation in terms of inner products without having identified an exact mapping Φ(•).

10. The information processing system of claim 9, wherein the feature space is a reproducing kernel Hilbert space.

11. The information processing system of claim 10, wherein the kernel content addressable memory is adapted to calculate the inner product between the set of transformed data in the feature space using the kernel function, by:
retrieving a desired pattern associated with the set of data from a corresponding input vector in the reproducing kernel Hilbert space by calculating:
$${d}_{r} = {\sum }_{i = 1}^{N} {d}_{i} \cdot {Φ}^{T} ( {x}_{i} ) \cdot Φ ( {x}_{r} ) = {\sum }_{i = 1}^{N} {d}_{i} \cdot K 〈 {x}_{i ,} {x}_{r} 〉$$
where d is an output state vector, K is the kernel function, r denotes a retrieved output vector, and i is an index, and
wherein the desired pattern is a sum of all stored output patterns weighed on a closeness of a current stimulus to a set of stored input patterns.

12. The information processing system of claim 8, wherein the kernel function is a Gaussian kernel
$$K ( {x}_{i} , {x}_{j} ) = exp ( \frac{- {‖ {x}_{i} - {x}_{j} ‖}^{2}}{2 {σ}^{2}} ) .$$

13. The method of claim 12 where the kernel function is any positive definite function of two arguments.

14. The information processing system of claim 9, wherein the Hilbert space is a function span of {K(•,x) x:∈X}.

15. A kernel content addressable memory for storing and retrieving data, the kernel content addressable memory being adapted to:
receive a set of data in an input space;
transform the input space comprising the set of data into a feature space of higher dimension, wherein the set of data is a set of transformed data within the feature space;
store the transformed data in a content addressable form; and
retrieve the transformed data in content addressable form by calculating an inner product between the set of transformed data in the feature space using a kernel function.

16. The kernel content addressable memory of claim 15, wherein the inner product between the set of transformed data in the feature space is calculated using the kernel function as follows:
let Φ(•) represent a mapping from the input space X into the feature space F, which is a Hilbert space, Φ:X→F, then the kernel function is K(xᵢ,xⱼ)= [symbol] Φ(xᵢ),Φ(xⱼ) [symbol] ,
wherein the kernel function computes the inner product by mapping the set of data into the feature space resulting in a non-linear transformation in terms of inner products without having identified an exact mapping Φ(•).

17. The kernel content addressable memory of claim 16, wherein the feature space is a reproducing kernel Hilbert space.

18. The kernel content addressable memory of claim 17, wherein the kernel content addressable memory is adapted to calculate the inner product between the set of transformed data in the feature space using the kernel function, by:
retrieving a desired pattern associated with the set of data from a corresponding input vector in the reproducing kernel Hilbert space by calculating:
$${d}_{r} = {\sum }_{i = 1}^{N} {d}_{i} \cdot {Φ}^{T} ( {x}_{i} ) \cdot Φ ( {x}_{r} ) = {\sum }_{i = 1}^{N} {d}_{i} \cdot K 〈 {x}_{i} , {x}_{r} 〉$$
where d is an output state vector, K is the kernel function, r denotes a retrieved output vector, and i is an index, and
wherein the desired pattern is a sum of all stored output patterns weighed on a closeness of a current stimulus to a set of stored input patterns.

19. The kernel content addressable memory of claim 15, wherein the kernel function is a Gaussian kernel
$$K ( {x}_{i} , {x}_{j} ) = exp ( \frac{- {‖ {x}_{i} - {x}_{j} ‖}^{2}}{2 {σ}^{2}} ) .$$

20. The kernel content addressable memory of claim 14, wherein the Hilbert space is a function span of {K(•,x):x∈X}.
